(19) United States
(12) Patent Application Publication
(10) Pub. No.: US 2026/0245975 A1
(43) Pub. Date: Aug. 20, 2026

(54) POWER STORAGE DEVICE

(71) Applicant: Prime Planet Energy & Solutions, Inc., Tokyo (JP)

(72) Inventor: Yozo UCHIDA, Toyota-shi (JP)

(21) Appl. No.: 19/430,260

(22) Filed: Dec. 23, 2025

(30) Foreign Application Priority Data
Feb. 20, 2025 (JP) 2025-025778

(51) Int. Cl. H01M 10/0587; H01M 10/0525; H01M 50/103; H01M 50/119; H01M 50/15; H01M 50/46

(52) U.S. Cl. CPC H01M 10/0587; H01M 10/0525; H01M 50/103; H01M 50/119; H01M 50/15; H01M 50/46

(57) ABSTRACT

A power storage device includes a plurality of flat wound electrode bodies and a case in which the plurality of electrode bodies is housed. The case includes a flat-plate-shaped first case wall portion contacting one of the electrode bodies on one side in an electrode-body thickness direction, a flat-plate-shaped second case wall portion contacting another one of the electrode bodies on the other side in the electrode-body thickness direction, and a third case wall portion having the same number of one-side semi-cylindrical inner wall surfaces as the number of the electrode bodies, arranged side by side in the electrode-body thickness direction. The one-side semi-cylindrical inner wall surfaces form semi-cylindrical surfaces conforming to outer peripheral surfaces of the one-side rounded portions of the electrode bodies and contacting the outer peripheral surfaces.

### CROSS-REFERENCE TO RELATED APPLICATIONS

This application is based upon and claims the benefit of priority to Japanese Patent Application No. 2025-025778 filed on Feb. 20, 2025, the entire contents of which are incorporated herein by reference.

### BACKGROUND

### Technical Field

The present disclosure relates to a power storage device, such as a battery and a capacitor, in which a plurality of flat wound electrode bodies is housed in a metal case.

### Related Art

Conventionally, batteries are known in each of which a plurality of flat wound electrode bodies is housed in a rectangular parallelepiped box-shaped metal case. In each of those batteries, two or more flat wound electrode bodies are stacked in the electrode-body thickness direction with their winding axes parallel, and housed in a case while they are covered by an insulating holder formed of an insulating film. One example of the conventional arts is disclosed in Japanese unexamined patent application publication No. 2024-175222 (JP 2024-175222 A).

### SUMMARY

### Technical Problems

Each of the flat wound electrode bodies is composed of a strip-shaped positive electrode plate and a strip-shaped negative electrode plate, which are wound together in a flat shape, having a rectangular parallelepiped electrode-body main portion and a pair of semi-cylindrical round portions (i.e., a one-side rounded portion and an other-side rounded portion) located on both sides of the electrode main body. In each battery mentioned above, the flat wound electrode bodies are stacked in contact with opposite first and second case wall portions of the case via the insulating holder. In contrast, each of the one-side rounded portions and each of the other-side rounded portions of the flat wound electrode bodies do not contact the case, forming a space between those rounded portions and the case. In the conventional batteries, consequently, heat conduction from the flat wound electrode bodies to the first case wall portion and the second case wall portion of the case is high, whereas heat conduction from the one-side rounded portions and the other-side rounded portions of the flat wound electrode bodies to the case is low.

The present disclosure has been made to address the above problems and has a purpose to provide a power storage device including a plurality of flat wound electrode bodies, enabling high heat conduction from the flat wound electrode bodies to a first case wall portion and a second case wall portion of a case, and moreover enabling high heat conduction from one-side rounded portions of the flat wound electrode bodies to a third case wall portion of the case.

### Means of Solving the Problems

(1) To achieve the above-mentioned purpose, one aspect of the disclosure provides a power storage device including: a case made of metal; and a plurality of flat wound electrode bodies housed in the case such that the plurality of flat wound electrode bodies are arranged with their winding axes parallel and stacked in an electrode-body thickness direction, wherein the case includes: a first case wall portion having a flat plate shape perpendicular to the electrode-body thickness direction and being located in direct or indirect contact with one of the plurality of flat wound electrode bodies in a stacked state on one side in the electrode-body thickness direction; a second case wall portion having a flat plate shape perpendicular to the electrode-body thickness direction, facing the first case wall portion, the second case wall portion being located in direct or indirect contact with another one of the plurality of flat wound electrode bodies in the stacked state on an other side opposite the one side in the electrode-body thickness direction; and a third case wall portion connecting the first case wall portion and the second case wall portion, and being located on one side in an electrode-body width direction perpendicular to the winding axes and the electrode-body thickness direction, each of the plurality of flat wound electrode bodies includes one-side rounded portions each having a semi-columnar shape and being located on the one side in the electrode-body width direction, the third case wall portion has a shape that a same number of one-side semi-cylindrical inner wall surfaces as the flat wound electrode bodies, each of the one-side semi-cylindrical inner wall surfaces forming a semi-cylindrical surface protruding on the one side in the electrode-body width direction to conform to outer peripheral surfaces of the one-side rounded portions, and the one-side semi-cylindrical inner wall surfaces being located in direct or indirect contact with the outer peripheral surfaces of the one-side rounded portions and arranged side by side in the electrode-body thickness direction.

In the above-described power storage device, the third case wall portion of the case is configured such that one-side semi-cylindrical inner wall surfaces, each having a semi-cylindrical surface as mentioned above, are arranged in a side-by-side relation. Not only the first case wall portion and the second case wall portion of the case are placed in contact with the stacked flat wound electrode bodies, but also the third case wall portion of the case is placed in contact with the one-side rounded portion of each of the flat wound electrode bodies. This configuration can enhance not only the heat conduction from the plurality of flat wound electrode bodies to the first case wall portion and the second case wall portion of the case, but also the heat conduction from the one-side rounded portions of the flat wound electrode bodies to the third case wall portion of the case. Consequently, this power storage device can be cooled effectively.
(2) In the power storage device described in (1), furthermore, the case includes fourth case wall portion connecting the first case wall portion and the second case wall portion, and being located on an other side opposite the one side in the electrode-body width direction, facing the third case wall portion, and each of the flat wound electrode bodies includes other-side rounded portions each having a semi-columnar shape and being located on the other side in the electrode-body width direction, and the fourth case wall portion has a shape that a same number of other-side semi-cylindrical inner wall surfaces as the flat wound electrode bodies, each of the other-side semi-cylindrical inner wall surfaces forming a semi-cylindrical surface protruding on the other side in the electrode-body width direction to conform to outer peripheral surfaces of the other-side rounded portions, and the other-side semi-cylindrical inner wall surfaces being located in direct or indirect contact with the outer peripheral surfaces of the other-side rounded portions and arranged side by side in the electrode-body thickness direction.
(3) In the power storage device described in (1), furthermore, the case includes: a case main body having a cylindrical shape, formed of an extruded product integrally including the first case wall portion, the second case wall portion, and the third case wall portion; and a pair of lid members closing a pair of opening portions of the case main body on both ends.
(4) In the power storage device described in (2), furthermore, the case includes: a case main body having a cylindrical shape, formed of an extruded product integrally including the first case wall portion, the second case wall portion, the third case wall portion, and the fourth case wall portion; and a pair of lid members closing a pair of opening portions of the case main body on both ends.

### BRIEF DESCRIPTION OF THE DRAWINGS

FIG. 1 is a perspective view of a battery in a first embodiment;

FIG. 2 is a cross-sectional view of the battery, cut along a line II-II in FIG. 3, in a battery height direction and a battery thickness direction in the first embodiment;

FIG. 3 is a partially cutaway view of the battery, cut along the battery height direction and a battery width direction in the first embodiment; and

FIG. 4 is a cross-sectional view of a battery, similar to FIG. 2, cut in the battery height direction and the battery thickness direction in a second embodiment.

### DETAILED DESCRIPTION OF THE EXEMPLARY EMBODIMENTS

### First Embodiment

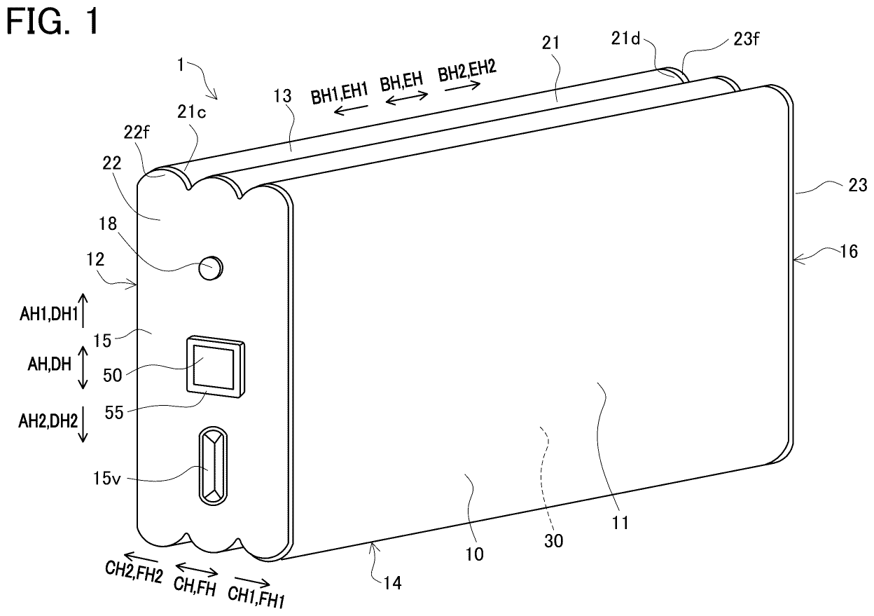

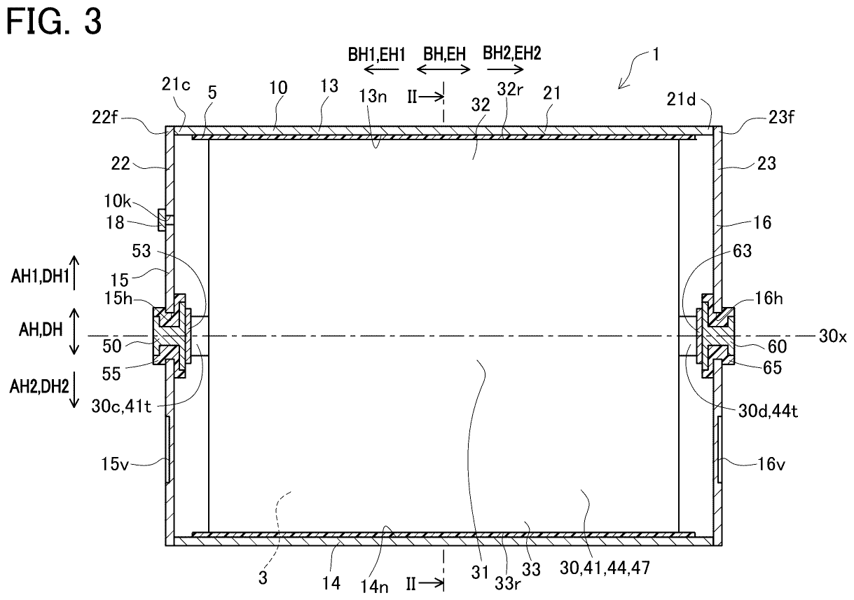

A detailed description of a first embodiment of this disclosure will now be given referring to the accompanying drawings. A battery 1 (one example of a power storage device of the disclosure) in the first embodiment as shown in FIGS. 1 to 3 is a sealed lithium-ion secondary battery, which will be mounted in vehicles, such as hybrid vehicles, plug-in hybrid vehicles, and electric vehicles. In the following description, the directions of the battery 1 are defined as a battery height direction AH, a battery width direction BH, and a battery thickness direction CH as shown in FIGS. 1 to 3.

The battery 1 is constituted of a case 10 made of metal (in the first embodiment, aluminum), a plurality of flat wound electrode bodies 30, e.g., three flat wound electrode bodies 30 in the first embodiment, housed in the case 10, which will be also referred simply to as an “electrode body” or “electrode bodies” 30, a positive terminal 50 fixed to the case 10 via a resin member 55, a negative terminal 60 fixed to the case 10 via a resin member 65, and others. Inside the case 10, the electrode bodies 30 are covered by a single insulating holder 5, which is formed of an insulating film and extends in a tubular shape in the battery width direction BH. Further, the case 10 contains an electrolyte 3, which is impregnated in each of the electrode bodies 30.

Each electrode body 30 includes a strip-shaped positive electrode plate 41 and a strip-shaped negative electrode plate 44, which are overlapped by alternately interposing two separators 47 each made of a strip-shaped resin porous film, and wound about a winding axis 30x into a cylindrical shape and then pressed into a flat shape. Each of the electrode bodies 30 has an elliptic cross-section perpendicular to an axial direction EH along the winding axis 30x and an oblong columnar outer shape extending in the axial direction EH. Each electrode body 30 includes a rectangular parallelepiped, electrode-body main portion 31 and a pair of semi-cylindrical rounded portions, i.e., a one-side rounded portion 32 and an other-side rounded portion 33, each being continuous to the electrode-body main portion 31.

In each electrode body 30, the electrode-body main portion 31 is the part where the positive electrode plate 41, negative electrode plate 44, and separators 47 are laminated flat one on another in their thickness direction. The one-side rounded portion 32 is located on one side DH1 (corresponding to an upper side AH1 in the battery height direction AH in the present embodiment) in the electrode-body width direction DH perpendicular to the axial direction EH and the electrode-body thickness direction FH. The other-side rounded portion 33 is located on the other side DH2 (corresponding to a lower side AH2 in the battery height direction AH in the present embodiment), opposite the one side DH1, in the electrode-body width direction DH. The one-side rounded portion 32 and the other-side rounded portion 33 are portions where the positive electrode plate 41, negative electrode plate 44, and separators 47 overlapping one another are curved in a semi-cylindrical shape.

Furthermore, each of the electrode bodies 30 includes a positive current collecting part 30c mentioned later at an end on one side EH1 (corresponding to one side BH1 in the battery width direction BH in the present embodiment) in the axial direction EH, and a negative current collecting part 30d mentioned later at an end on the other side EH2 (corresponding to the other side BH2 in the battery width direction BH in the present embodiment) in the axial direction EH.

The positive electrode plate 41 has a positive current collecting foil formed of a strip-shaped aluminum foil. On each main surface of this foil, a positive active material layer is formed, containing positive active material particles capable of absorbing and releasing lithium ions. The positive electrode plate 41 includes a plurality of positive electrode extended portions 41t extending out from a central portion in the electrode-body width direction DH, on the one side EH1 in the axial direction EH. Each of the positive electrode extended portions 41t is formed of the positive current collecting foil exposed where the positive active material layer is not formed. Those positive electrode extended portions 41t overlap each other in the thickness direction, forming the positive current collecting part 30c. This positive current collecting part 30c is bonded (in the present embodiment, by ultrasonic welding) to a rectangular plate-like positive current collecting member 53, and further the positive current collecting member 53 is bonded (in the present embodiment, by laser welding) to the positive terminal 50.

The negative electrode plate 44 has a negative current collecting foil formed of a strip-shaped copper foil. On each main surface of this foil, a negative active material layer is formed, containing negative active material particles capable of absorbing and releasing lithium ions. The negative electrode plate 44 includes a plurality of negative electrode extended portions 44t extending out from a central portion in the electrode-body width direction DH, on the other side EH2 in the axial direction EH. Each of the negative electrode extended portions 44t is formed of the negative current collecting foil exposed where the negative active material layer is not formed. Those negative electrode extended portions 44t overlap each other in the thickness direction, forming the negative current collecting part 30d. This negative current collecting part 30d is bonded (in the present embodiment, by ultrasonic welding) to a rectangular plate-like negative current collecting member 63, and further the negative current collecting member 63 is bonded (in the present embodiment, by laser welding) to the negative terminal 60.

The electrode bodies 30 are stacked in the electrode-body thickness direction FH so that their winding axes 30x are parallel to each other. Those electrode bodies 30 are housed in the case 10 via the insulating holder 5. In the first embodiment, the electrode-body width direction DH of each electrode body 30 coincides with the battery height direction AH, the axial direction EH of each electrode body 30 coincides with the battery width direction BH, and the electrode-body thickness direction FH of each electrode body 30 coincides with the battery thickness direction CH.

Next, the case 10 will be described below. The case 10 is composed of six case wall portions, i.e., a first case wall portion 11, a second case wall portion 12, a third case wall portion 13, a fourth case wall portion 14, a fifth case wall portion 15, and a sixth case wall portion 16. In the first embodiment, the third case wall portion 13 is an upper wall portion of the case 10, the fourth case wall portion 14 is a bottom wall portion of the case 10, the remaining first case wall portion 11, the second case wall portion 12, the fifth case wall portion 15, and the sixth case wall portion 16 are side wall portions of the case 10.

The first case wall portion 11 and the second case wall portion 12 each have a flat plate-like shape. These first case wall portion 11 and second case wall portion 12 face each other. Specifically, the first case wall portion 11 is located on the one side CH1 in the battery thickness direction CH and the second case wall portion 12 is located on the other side CH2 in the battery thickness direction CH.

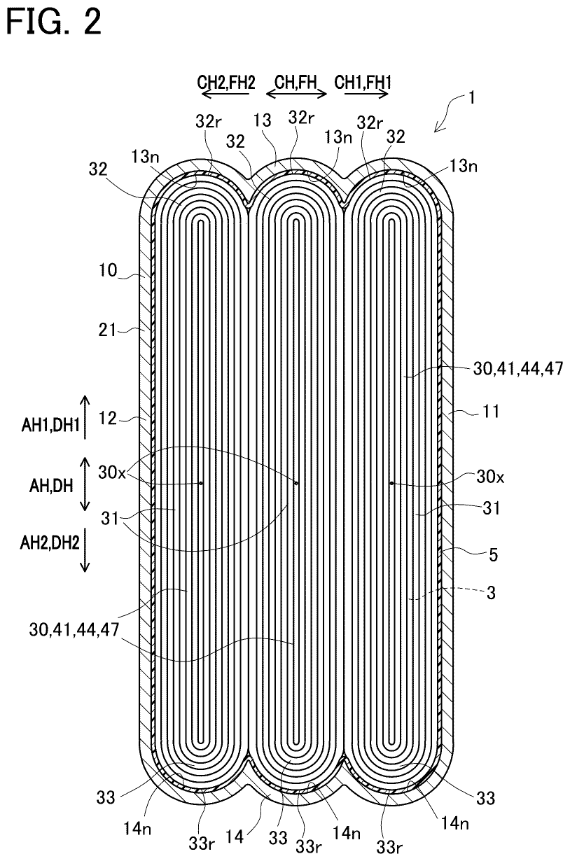

The first case wall portion 11 is perpendicular to the electrode-body thickness direction FH, and is placed in surface contact with one of the electrode bodies 30 stacked as above (specifically, the electrode-body main portion 31 of the rightmost electrode body 30 in FIG. 2), indirectly via the insulating holder 5, on one side FH1 in the electrode-body thickness direction FH. That is, the flat inner wall surface of the first case wall portion 11 and the flat surface of the corresponding electrode-body main portion 31 are in surface contact with each other. This configuration enables high heat conduction from the stacked electrode bodies 30 to the first case wall portion 11.

The second case wall portion 12 is perpendicular to the electrode-body thickness direction FH, and is placed in surface contact with another one of the electrode bodies 30 stacked as above (specifically, the electrode-body main portion 31 of the leftmost electrode body 30 in FIG. 2), indirectly via the insulating holder 5, on the other side FH2 in the electrode-body thickness direction FH. That is, the flat inner wall surface of the second case wall portion 12 and the flat surface of the electrode-body main portion 31 are in surface contact with each other. This configuration enables high heat conduction from the stacked electrode bodies 30 to the second case wall portion 12.

The third case wall portion 13 and the fourth case wall portion 14 are located facing each other and each connecting the first case wall portion 11 and the second case wall portion 12. The third case wall portion 13 is located on the upper side AH1 in the battery height direction AH (one side DH1 in the electrode-body width direction DH) and the fourth case wall portion 14 is located on the lower side AH2 in the battery height direction AH (the other side DH2 in the electrode-body width direction DH).

The third case wall portion 13 has a shape that the same number of the one-side semi-cylindrical inner wall surfaces 13n as the number of the electrode bodies 30 (in the first embodiment, three one-side semi-cylindrical inner wall surfaces 13n) are arranged side by side in the electrode-body thickness direction FH. Each of the one-side semi-cylindrical inner wall surfaces 13n has a semi-cylindrical surface protruding on one side DH1 in the electrode-body width direction DH, conforming to the shape of the semi-cylindrical outer peripheral surface 32r of the corresponding one-side rounded portion 32. In the first embodiment, the thickness of the third case wall portion 13 is substantially uniform, and accordingly the third case wall portion 13 is shaped such that two or more semi-cylindrical wall portions are arranged in a corrugated pattern in the electrode-body thickness direction FH. Each of the one-side semi-cylindrical inner wall surfaces 13n of the third case wall portion 13 is in surface contact with the one-side rounded portion 32 of the corresponding electrode body 30, indirectly via the insulating holder 5, that is, the one-side semi-cylindrical inner wall surface 13n and the outer peripheral surface 32r are in surface contact with each other. This configuration enables high heat conduction from each of the one-side rounded portions 32 to the third case wall portion 13.

The fourth case wall portion 14 has a shape that the same number of the other-side semi-cylindrical inner wall surfaces 14n as the number of the electrode bodies 30 (in the first embodiment, three other-side semi-cylindrical inner wall surfaces 14n) are arranged side by side in the electrode-body thickness direction FH. Each of the other-side semi-cylindrical inner wall surfaces 14n has a semi-cylindrical surface protruding on the other side DH2 in the electrode-body width direction DH, conforming to the shape of the semi-cylindrical outer peripheral surface 33r of the corresponding other-side rounded portion 33. In the first embodiment, the thickness of the fourth case wall portion 14 is substantially uniform, and accordingly the fourth case wall portion 14 is shaped such that two or more semi-cylindrical wall portions are arranged in a corrugated pattern in the electrode-body thickness direction FH. Each of the other-side semi-cylindrical inner wall surfaces 14n of the fourth case wall portion 14 is in surface contact with the other-side rounded portion 33 of the corresponding electrode body 30, indirectly via the insulating holder 5, that is, the other-side semi-cylindrical inner wall surface 14n and the outer peripheral surface 33r are in surface contact with each other. This configuration enables high heat conduction from each of the other-side rounded portions 33 to the fourth case wall portion 14.

The fifth case wall portion 15 and the sixth case wall portion 16 each have a flat plate-like shape. These fifth case wall portion 15 and sixth case wall portion 16 are perpendicular to the axial direction EH of each electrode body 30 and face each other. Specifically, the fifth case wall portion 15 is located on one side BH1 in the battery width direction BH and the sixth case wall portion 16 is located on the other side BH2 in the battery width direction BH. Those fifth case wall portion 15 and sixth case wall portion 16 are spaced apart from the electrode-body main portions 31, the one-side rounded portions 32, and the other-side rounded portions 33 of the electrode bodies 30.

The positive terminal 50 made of aluminum is hermetically fixed to the fifth case wall portion 15. Specifically, the fifth case wall portion 15 has an insertion hole 15h in which the positive terminal 50 is inserted, extending from the inside to the outside of the case 10. Further, the positive terminal 50 is fixed to the fifth case wall portion 15 via the resin member 55 formed by insert molding, thus insulating the positive terminal 50 from the fifth case wall portion 15. The positive terminal 50 is electrically connected to the positive current collecting parts 30c of the electrode bodies 30 via the positive current collecting member 53 inside the case 10. Further, the fifth case wall portion 15 is provided with a safety valve 15v that breaks and opens when the internal pressure of the case 10 exceeds a valve opening pressure. The fifth case wall portion 15 is further provided with a liquid inlet 10k, which is hermetically sealed by a disk-shaped seal member 18.

The negative terminal 60 made of copper is hermetically fixed to the sixth case wall portion 16. Specifically, the sixth case wall portion 16 has an insertion hole 16h in which the negative terminal 60 is inserted, extending from the inside to the outside of the case 10. Further, the negative terminal 60 is fixed to the sixth case wall portion 16 via the resin member 65 formed by insert molding, thus insulating the negative terminal 60 from the sixth case wall portion 16. The negative terminal 60 is electrically connected to the negative current collecting parts 30d of the electrode bodies 30 via the negative current collecting member 63 inside the case 10 as described above. The sixth case wall portion 16 is provided with a safety valve 16v as with the fifth case wall portion 15.

The case 10 described above is made by joining a cylindrical case main body 21 to a pair of plate-shaped lid members, i.e., a first lid member 22 and a second lid member 23. In the first embodiment, the case main body 21 is composed of a single member, specifically, an extruded product manufactured by extrusion molding. The first lid member 22 and the second lid member 23 are also single members.

The case main body 21 extends in the battery width direction BH, and has a first opening portion 21c on one side BH1 in the battery width direction BH and a second opening portion 21d on the other side BH2 in the battery width direction BH. This case main body 21 integrally includes the first case wall portion 11, second case wall portion 12, third case wall portion 13, and fourth case wall portion 14. In the case main body 21, the plurality of electrode bodies 30 is housed.

The first lid member 22 forms the fifth case wall portion 15 of the case 10. This first lid member 22 hermetically closes the first opening portion 21c of the case main body 21. Specifically, a circumferential edge portion 22f of the first lid member 22 is placed to cover the first opening portion 21c of the case main body 21 and, in this state, a laser beam is applied onto the entire circumference of the first opening portion 21c and the circumferential edge portion 22f from the outside of the case main body 21 in the radial direction, i.e., in the direction perpendicular to the battery width direction BH, hermetically welding the first opening portion 21c and the circumferential edge portion 22f over their entire circumference.

The second lid member 23 forms the sixth case wall portion 16 of the case 10. This second lid member 23 hermetically closes a second opening portion 21d of the case main body 21. Specifically, the second opening portion 21d of the case main body 21 and a circumferential edge portion 23f of the second lid member 23 are hermetically laser-welded over their entire circumference in a similar manner to the first opening portion 21c of the case main body 21 and the circumferential edge portion 22f of the first lid member 22 as mentioned above.

In the battery 1 in the first embodiment, the third case wall portion 13 of the case 10 is configured such that two or more one-side semi-cylindrical inner wall surfaces 13n, which form the semi-cylindrical surfaces as described above, are arranged in parallel rows. Not only the first case wall portion 11 and the second case wall portion 12 of the case 10 are in contact with the corresponding electrode bodies 30 in the stacked state, but also the third case wall portion 13 of the case 10 is in contact with the one-side rounded portions 32 of the electrode bodies 30. Thus, not only the heat conduction from the electrode bodies 30 to the first case wall portion 11 and second case wall portion 12 of the case 10 can be enhanced, but also the heat conduction from the one-side rounded portions 32 of the electrode bodies 30 to the third case wall portion 13 of the case 10 can also be enhanced. Consequently, the battery 1 in the first embodiment can be cooled more effectively compared to a battery configured such that a third case wall portion of a case has a flat plate-like shape, providing a space between the third case wall portion and one-side rounded portions of two or more electrode bodies. Further, the third case wall portion 13 of the case 10 is designed such that two or more one-side semi-cylindrical inner wall surfaces 13n are arranged in a side-by-side relation, thereby enhancing the rigidity of the case 10.

Moreover, in the battery 1, the fourth case wall portion 14 of the case 10 is configured such that two or more other-side semi-cylindrical inner wall surfaces 14n, which form the semi-cylindrical surfaces as described above, are arranged in parallel rows. This fourth case wall portion 14 is placed in contact with each of the other-side rounded portions 33 of the electrode bodies 30. Thus, the heat conduction from the other-side rounded portions 33 of the electrode bodies 30 to the fourth case wall portion 14 of the case 10 can be enhanced. The fourth case wall portion 14 of the case 10 is designed such that two or more other-side semi-cylindrical inner wall surfaces 14n are arranged in a side-by-side relation, thereby further enhancing the rigidity of the case 10.

In the battery 1, the case main body 21 including the first case wall portion 11, second case wall portion 12, third case wall portion 13, and fourth case wall portion 14 is a cylindrical extruded product. This case main body 21 can therefore be easily shaped such that the third case wall portion 13 has two or more one-side semi-cylindrical inner wall surfaces 13n arranged side by side and the fourth case wall portion 14 has two or more other-side semi-cylindrical inner wall surfaces 14n arranged side by side. Consequently, the battery 1 can be provided at a low cost, even though the third case wall portion 13 and the fourth case wall portion 14 are complicated in shape.

### Second Embodiment

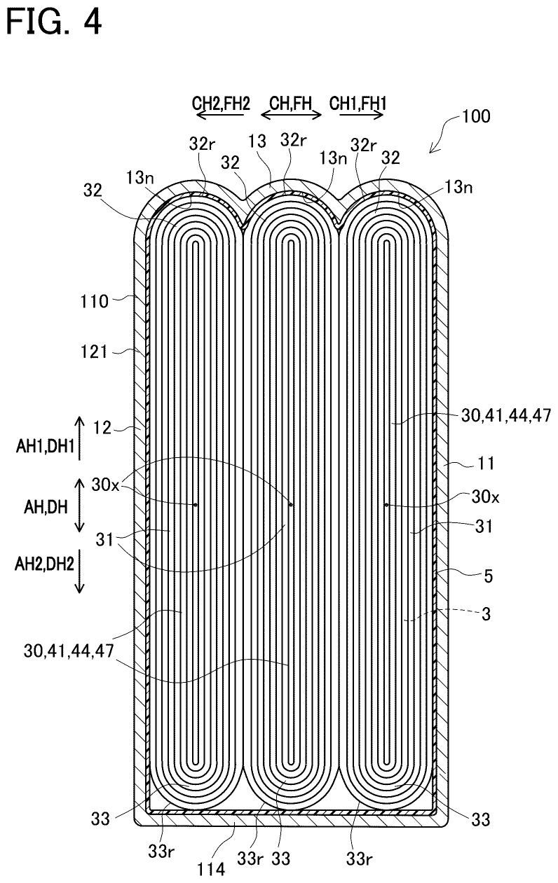

Next, a second embodiment of the power storage device will be described below, referring to FIG. 4. The descriptions of identical or similar parts to those in the first embodiment are omitted or simplified. A battery 100 (another example of the power storage device of the disclosure) in the second embodiment includes a case 110, different in configuration from the case 10 of the battery 1 in the first embodiment.

Specifically, the case 10 in the first embodiment is configured such that the third case wall portion 13 has a shape that the one-side semi-cylindrical inner wall surfaces 13n, each forming a semi-cylindrical surface, are arranged side by side, and further the fourth case wall portion 14 has a shape that the other-side semi-cylindrical inner wall surfaces 14n, each forming a semi-cylindrical surface, are arranged side by side.

In contrast, the case 110 in the second embodiment is configured such that only the third case wall portion 13 has a shape that the one-side semi-cylindrical inner wall surfaces 13n, each forming a semi-cylindrical surface are arranged side by side, but the fourth case wall portion 14 has a flat plate-like shape. Remaining case wall portions, i.e., the first case wall portion 11, second case wall portion 12, fifth case wall portion 15, and sixth case wall portion 16, are identical to those in the first embodiment.

In the battery 100 in the second embodiment, as in the first embodiment, the third case wall portion 13 of the case 110 includes two or more one-side semi-cylindrical inner wall surfaces 13n, each forming a semi-cylindrical surface, which are arranged side by side, and placed in contact with the semi-cylindrical outer peripheral surfaces 32r of the one-side rounded portions 32 of the electrode bodies 30. This configuration can enhance the heat conduction from the one-side rounded portions 32 of the electrode bodies 30 to the third case wall portion 13 of the case 110.

In the battery 100, the case main body 121 including the first case wall portion 11, the second case wall portion 12, the third case wall portion 13, and a fourth case wall portion 114 is a cylindrical extruded product. This case main body 121 can therefore be easily shaped such that the third case wall portion 13 has two or more one-side semi-cylindrical inner wall surfaces 13n arranged side by side. Consequently, the battery 100 can be provided at a low cost, even though the third case wall portion 13 is complicated in shape. Further, similar or identical parts to those in the first embodiment can achieve the same operations and effects as in the first embodiment.

The present disclosure is described in the foregoing first and second embodiments, but is not limited thereto. The disclosure may be embodied in other specific forms without departing from the essential characteristics thereof.

For instance, in the first and second embodiments, the power storage devices are illustrated by the lithium-ion secondary batteries, but are not limited thereto. The power storage device may further include, for example, a secondary battery such as a sodium-ion secondary battery and a calcium-ion secondary battery, as well as a capacitor such as a lithium-ion capacitor.

Each of the first and second embodiments shows the battery 1, 100 configured such that the case 10, 110 is placed in indirect contact with the electrode bodies 30 via the insulating holder 5. However, the case and the electrode body may be placed in direct contact with each other. Another alternative may be configured such that the first case wall portion and the second case wall portion directly contact the electrode-body main portions of the electrode bodies, the third case wall portion directly contacts the one-side rounded portions of the electrode bodies, and the fourth case wall portion directly contacts the other-side rounded portions of the electrode bodies.

### Reference Signs List

1, 110 Battery (Power storage device)
10, 110 Case
11 First case wall portion
12 Second case wall portion
13 Third case wall portion
13n One-side semi-cylindrical inner wall surface
14, 114 Fourth case wall portion
14n Other-side semi-cylindrical inner wall surface
15 Fifth case wall portion
16 Sixth case wall portion
21, 121 Case main body
21c First opening portion
21d Second opening portion
22 First lid member
23 Second lid member
30 Electrode body (Flat wound electrode body)
30x Winding axis
31 Electrode-body main portion
32 One-side rounded portion
32r Outer peripheral surface (of one-side rounded portion)
33 Other-side rounded portion (of other-side rounded portion)
41 Positive electrode plate
44 Negative electrode plate
DH Electrode-body width direction
EH Axial direction
FH Electrode-body thickness direction
FH1 One side (in electrode-body thickness direction)
FH2 Other side (in electrode-body thickness direction)

What is claimed is:

1. A power storage device comprising:
a case made of metal; and
a plurality of flat wound electrode bodies housed in the case such that the plurality of flat wound electrode bodies are arranged with their winding axes parallel and stacked in an electrode-body thickness direction,
wherein the case includes:
a first case wall portion having a flat plate shape perpendicular to the electrode-body thickness direction and being located in direct or indirect contact with one of the plurality of flat wound electrode bodies in a stacked state on one side in the electrode-body thickness direction;
a second case wall portion having a flat plate shape perpendicular to the electrode-body thickness direction, facing the first case wall portion, the second case wall portion being located in direct or indirect contact with another one of the plurality of flat wound electrode bodies in the stacked state on an other side opposite the one side in the electrode-body thickness direction; and
a third case wall portion connecting the first case wall portion and the second case wall portion, and being located on one side in an electrode-body width direction perpendicular to the winding axes and the electrode-body thickness direction,
each of the plurality of flat wound electrode bodies includes one-side rounded portions each having a semi-columnar shape and being located on the one side in the electrode-body width direction,
the third case wall portion has a shape that a same number of one-side semi-cylindrical inner wall surfaces as the flat wound electrode bodies, each of the one-side semi-cylindrical inner wall surfaces forming a semi-cylindrical surface protruding on the one side in the electrode-body width direction to conform to outer peripheral surfaces of the one-side rounded portions, and
the one-side semi-cylindrical inner wall surfaces being located in direct or indirect contact with the outer peripheral surfaces of the one-side rounded portions and arranged side by side in the electrode-body thickness direction.

2. The power storage device according to claim 1, wherein
the case includes a fourth case wall portion connecting the first case wall portion and the second case wall portion, and being located on an other side opposite the one side in the electrode-body width direction, facing the third case wall portion, and
each of the flat wound electrode bodies includes other-side rounded portions each having a semi-columnar shape and being located on the other side in the electrode-body width direction, and
the fourth case wall portion has a shape that a same number of other-side semi-cylindrical inner wall surfaces as the flat wound electrode bodies, each of the other-side semi-cylindrical inner wall surfaces forming a semi-cylindrical surface protruding on the other side in the electrode-body width direction to conform to outer peripheral surfaces of the other-side rounded portions, and
the other-side semi-cylindrical inner wall surfaces being located in direct or indirect contact with the outer peripheral surfaces of the other-side rounded portions and arranged side by side in the electrode-body thickness direction.

3. The power storage device according to claim 1, wherein
the case includes:
a case main body having a cylindrical shape, formed of an extruded product integrally including the first case wall portion, the second case wall portion, and the third case wall portion; and
a pair of lid members closing a pair of opening portions of the case main body on both ends.

4. The power storage device according to claim 2, wherein
the case includes:
a case main body having a cylindrical shape, formed of an extruded product integrally including the first case wall portion, the second case wall portion, the third case wall portion, and the fourth case wall portion; and
a pair of lid members closing a pair of opening portions of the case main body on both ends.
